(19) United States
(12) Patent Application Publication
(10) Pub. No.: US 2018/0284468 A1
(43) Pub. Date: Oct. 4, 2018

(54) HEAD-MOUNTED STEREOSCOPIC VIEWING APPARATUS

(71) Applicants: Kevin P. Parker, Berkeley, CA (US); Wayne Kasom, Oakland, CA (US)

(72) Inventors: Kevin P. Parker, Berkeley, CA (US); Wayne Kasom, Oakland, CA (US)

(21) Appl. No.: 15/476,974

(22) Filed: Apr. 1, 2017

(51) Int. Cl. G02B 27/22

(52) U.S. Cl. CPC G02B 27/2242

(57) ABSTRACT

A head-mounted stereoscopic viewing apparatus is disclosed including a viewer section and a head mount secured to the viewer section for receiving a head strap. The head mount, which is preferably formed from a single sheet of heavy paper, includes a forehead segment, a left and right side segments extend from respective left and right end portion of the forehead segment and left and right lower segments extend from respective left and right side segments over a lower section of a housing of the viewer. The head mount from the left lower segment, through the left side segment, the forehead segment, the right side segment and the right lower segment form a continuous structure.

### BACKGROUND OF THE INVENTION

### 1. Field of the Invention

The present invention relates generally to optical viewing apparatus and, in particular, to a head-mounted viewing apparatus for use with a display apparatus such as a cellular telephone of the type commonly referred to as SmartPhones.

### 2. Description of Related Art

Stereoscopic viewing apparatus are well known in the art. Referring now to the drawings, FIGS. 1 and 2 are two views a conventional handheld stereoscopic viewing apparatus, depicted generally by the numeral 20. As will be explained later in greater detail, apparatus 20 operates in conjunction with a suitably programmed conventional portable cellular telephone commonly referred to as a SmartPhone (sometimes generally referred to herein as a display apparatus). Viewing apparatus 20 and the SmartPhone operate together to provide a virtual reality (“VR”) experience which is relatively advanced, particularly when considering the potential low cost of viewing apparatus 20 which can be used with most existing modern SmartPhones.

A large variety of software, primarily in the form of mobile apps, can be readily downloaded from the Internet onto a user's SmartPhone to enable the phone to generate images that provide a Virtual Reality experience. One popular app is called Google Cardboard™ and is available on Apple's on line store at apple.com. FIG. 4 depicts an exemplary screen shot of a programmed SmartPhone display which includes a left (from a viewer's perspective) image region 46L and a right image region 46R. Also shown is image separation icon 46B and menu icon 46A. The two separate images 46L and 46R are of the same scene but are offset from one another. The viewing apparatus 20 functions to project the two images onto the respective left and right eyes of the viewer. As is well known, the two dimensional (2D) images are combined in the brain to produce the illusion of a single three dimensional (3D) image.

The majority of modern SmartPhones, such as those of the Apple iPhone® series include various internal sensors such as accelerometers, magnetometers and gyroscopes. These sensors can be used to detect rotational movement of the phone about all three axis. Further, the programmed image pairs, such as those of FIG. 4, are taken from all 360 degrees of the object. Thus, when the programmed phone is installed in the viewing apparatus 20 and the apparatus is positioned over the viewer's eyes, the phone sensors are able to detect rotational movement of the user's head and thereby control the generation of appropriate image pairs. In this manner, the user is able to observe the image object from any direction in 3D using natural head movements. Thus, the user is able to enjoy a VR experience.

Returning to the drawings, viewing apparatus 20 includes a housing 22 which, along with many other of the viewer components, can be fabricated from cardboard or other similar forms of semi-rigid paper. A front cut-out in the housing 22, with the outer edge preferably being covered in part by a soft cushion 40, is adapted to conform to a user's face. A pair of bi-convex lenses 44L and 44R are mounted on a lens support panel 42 secured within the housing. The lenses are preferably positioned near the user's eyes when the handheld viewing device is in operation. Lenses having a diameter of 33.4 mm and a focal length of 76 mm have been found suitable for this application. Lenses 44L and 44R, which are readily available from many sources at a relatively low cost, are positioned relative to a SmartPhone screen installed on the viewing device a distance about equal to 65 mm for this lens focal length. Thus, when so positioned the lenses provide a degree of image magnification and further place the virtual image of the screen near infinity so as to minimize eye strain. Lenses 44L and 44R may be individually set on panel 42 by way of screw mounts so that the position of each lens relative to the user's eyes can be individually adjusted to compensate for eyesight differences.

Viewing apparatus 20 preferably includes some mechanism for controlling operation of the SmartPhone while the viewing apparatus is positioned over the viewer's face. In the present example, the touch screen function of the SmartPhone is used as will be described. The interior of housing 22 includes a partition 34 (FIG. 2) disposed intermediate the lenses 44L and 44R. Partition 34 includes an extension in the form of an actuator arm 28. Arm 28 together with partition 34 are pivotally mounted within the housing so as to be movable between a retracted position as depicted in FIG. 2 and an actuating position (not depicted). When a user button 28A is depressed, a screen contactor 28B pivots forward to contact the SmartPhone screen. A spring (not depicted) operates to return the arm 28 and partition 34 to the retracted position after screen actuation is completed when the user releases button 28A. When in the retracted position, partition 34 and arm 28 limit light from the right image region 46R (FIG. 4) of SmartPhone reaching the user's left eye and limit light from the left image region 46L reaching the user's right eye so as to enhance the 3D effect.

Pivotable arm 28 is connected to actuator button 28A which extends through an opening in housing 22 to provide access to the button. An electrically conductive path is created from the user's finger by way of button 28A to display contactor 28B so that a conventional capacitive/conductive touch screen can detect the presence of contactor 28B when it is forced against the screen. Another common alternative approach to screen actuation can be used in the event the SmartPhone includes a magnetometer. A small movable magnet is mounted on housing 22 near the SmartPhone which can be manually toggled between two positions. This change in position can be detected by the SmartPhone magnetometer and used to control phone operation in much the same manner as display contactor 28B.

As can best be seen in FIGS. 2 and 3, housing 22 includes a back panel 24 which can be opened to receive a SmartPhone 30S (shown in phantom in FIG. 3) and closed to secure the SmartPhone in place. Back panel 24 is connected to the lower portion of the housing 22 by a back panel bottom segment 24B. A folding line 29B is formed in the back panel 24 by scoring the panel to facilitate folding. A top panel segment 24A is provided to hold the closed panel in place. Segment 24A is separated from back panel 24 by a fold line 29A created by scoring. One side 32A of a loop and hook fastener is secured at an appropriate location on the top of housing 22, with the mating side 32B of the fastener being secured to the top panel segment 24A. A foam layer 38 is sandwiched between the back panel 24 and a panel member 36, with the foam layer becoming compressed when a SmartPhone 30S is installed so as to apply a holding force against the back of the phone by way of panel member 36.

Although the prior art viewing apparatus 20 is capable of providing an enjoyable VR viewing experience, certain improvements could be made. In particular, a viewer that provides hands-free operation is very desirable. Such viewers are readily available in the prior art. However, the mechanism for securing the prior art viewing apparatus to the user's head is invariably quite complex, or is uncomfortable or both. The present invention provides a viewer that can be comfortably and reliably supported on the user's head and yet can also be easily manufactured using light, low cost materials. These and other advantages of the present invention will become apparent to those skilled in the art from a reading of the following Detailed Description of the Invention together with the drawings.

### SUMMARY OF THE INVENTION

A head-mounted stereoscopic viewing apparatus is disclosed. The viewing apparatus includes a viewer section which includes a viewer housing having means for securing a display device at one end, such as a SmartPhone. Lenses are disposed within the viewer housing. A head mount is included to provide, along with a head strap secured to the head mount, hands-free viewing. The head mount includes an elongated forehead segment which extends along an upper edge of the viewing end of the viewer housing. The head mount further includes left and right lower segments extending across at least a portion of the lower housing section. A left side segment of the head mount extends from a left end portion of the forehead segment to the left lower segment and a right side segment extends from a right end portion of the forehead section to the right lower segment. Preferably, the head mount from the left lower segment, through the left side segment, the forehead segment, the right side segment and to the right lower segment forms a continuous structure.

The head mount can be readily fabricated from a single sheet of material such as heavy paper. When still in sheet (planar) form, the regions that will form the left and right lower segments are each twisted relative to the region that will form the forehead segment to convert the two-dimensional planar structure into a three-dimensional structure that is secured to the viewer housing. The left lower segment is twisted in a clockwise direction and the right lower section is twisted in a counter clockwise direction. The two lower sections of the head mount are secured to the exterior of the lower housing section of the viewer section. The head strap can be secured to the head mount near the left and right end portions of the forehead section which, along with the forehead segment, functions to encircle the user's head.

### BRIEF DESCRIPTION OF THE DRAWINGS

FIG. 1 is front perspective view of a prior art stereoscopic viewing apparatus.

FIG. 2 is a rear perspective view of the prior art stereoscopic viewing apparatus of FIG. 1 with a hinged rear cover open for receiving a SmartPhone.

FIG. 3 is a side sectional view showing a SmartPhone in phantom installed in the prior art viewing apparatus of FIG. 1.

FIG. 4 is prior art SmartPhone screen shot showing an exemplary stereoscopic image to be viewed on the viewing apparatus of FIG. 1.

FIG. 5 is a perspective view of the viewer section of an exemplary embodiment of the present invention with the head mount and head strap removed for purposes of illustration.

FIG. 6 is a plan view of the head mount of the exemplary embodiment of the present invention, the head mount being in planar form prior to installation of the head mount on the viewer section.

FIG. 7 is a top view of the head mount of FIG. 6 after installation on the viewer section, with the viewer section and head strap being removed for purposes of illustration.

FIG. 8 is a perspective view of the head mount of FIG. 6 together with the head strap after installation on the viewer section, with the viewer section being removed for purposes of illustration.

FIGS. 9A-9C are various perspective views of an exemplary embodiment of the present invention, including the viewer section, the head mount and the head strap.

FIG. 10 is a bottom view of the exemplary embodiment of FIGS. 9A-9C.

FIGS. 11A and 11B are perspective views of the exemplary embodiment of FIGS. 9A-9C positioned on a user's head.

### DETAILED DESCRIPTION OF THE INVENTION

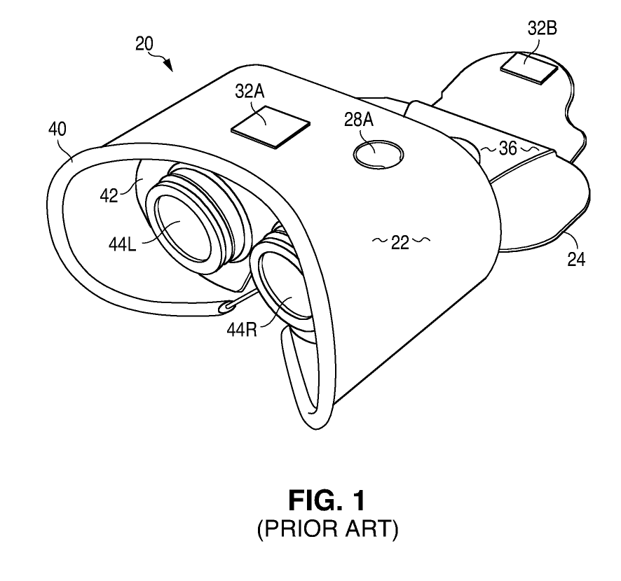

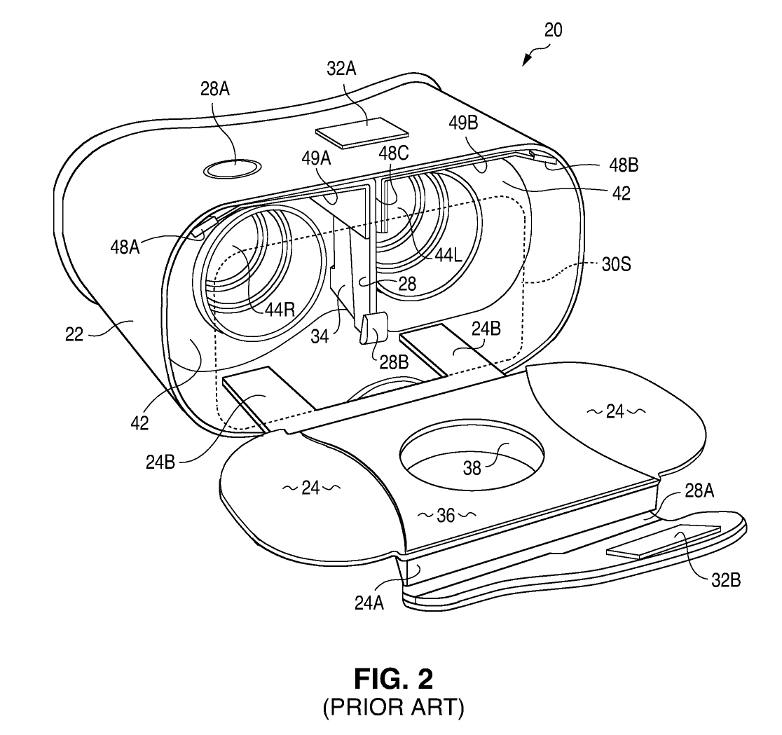

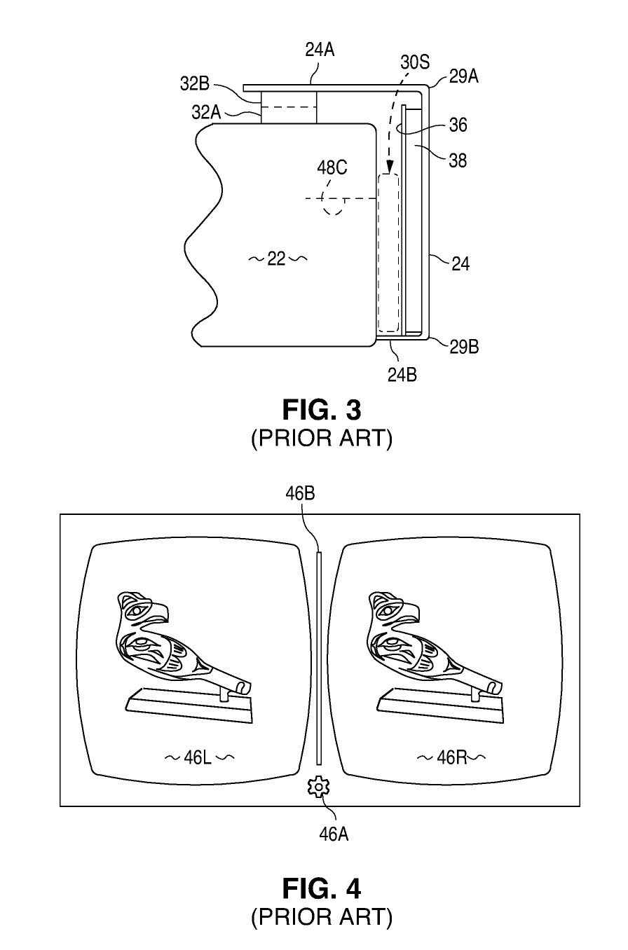

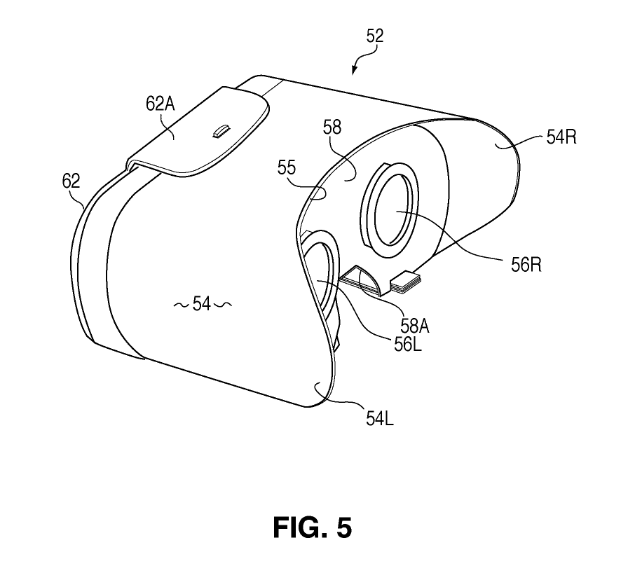

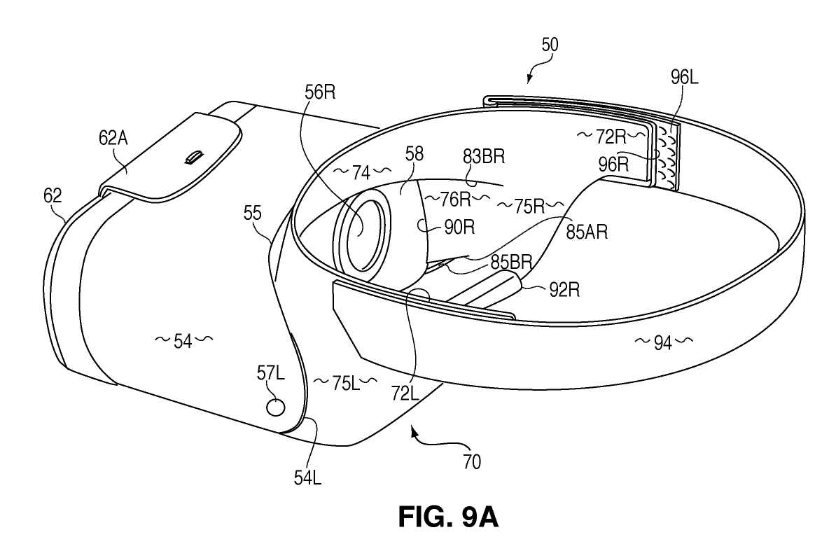

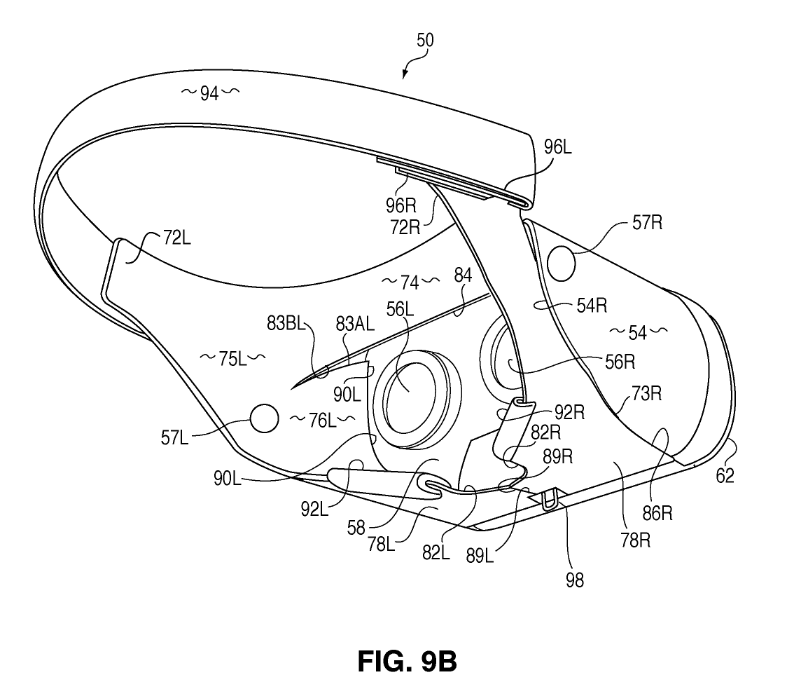

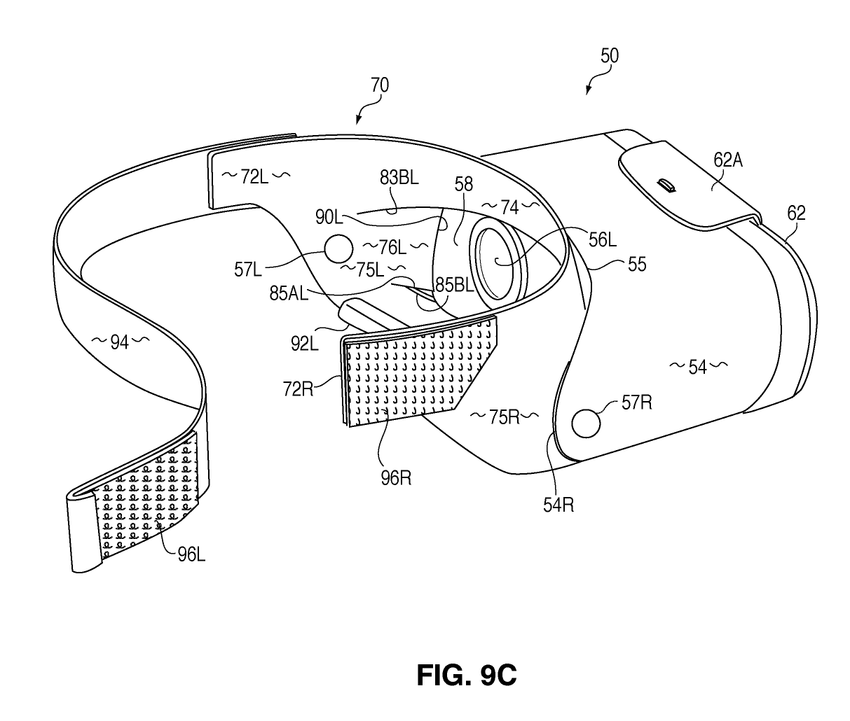

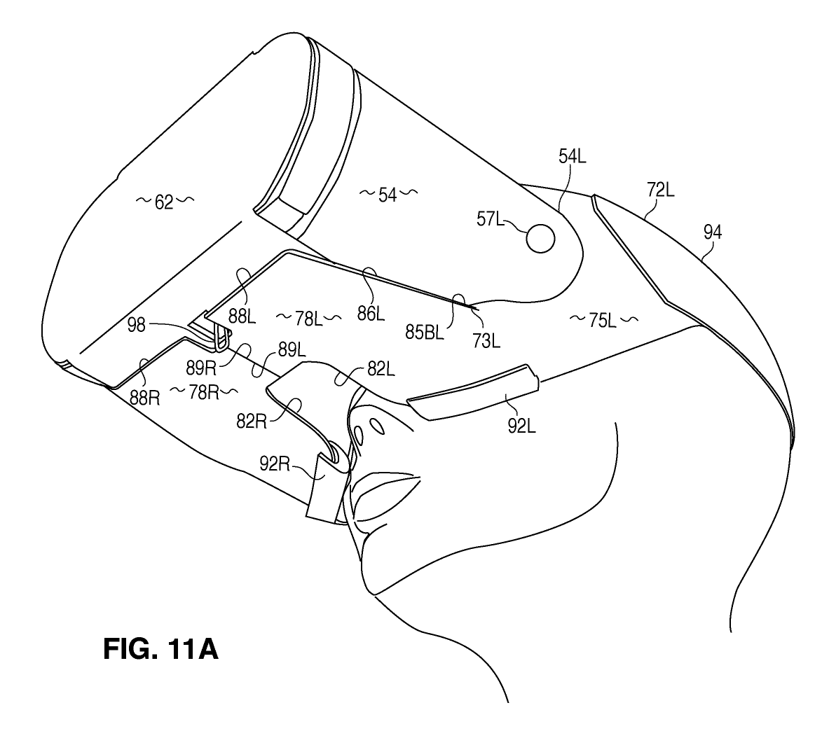

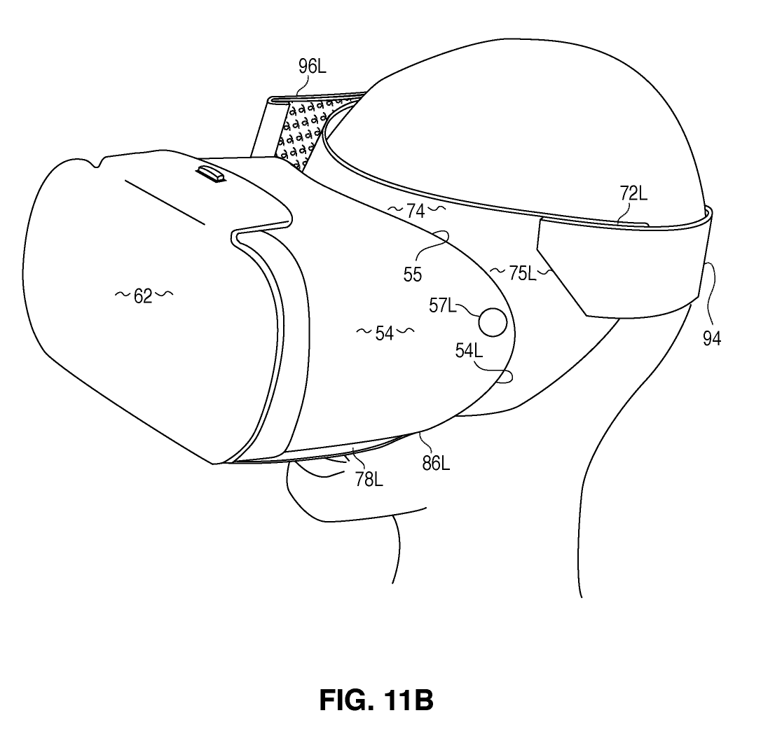

Returning to the drawings, FIGS. 9A-9C depict one embodiment, generally designated by the numeral 50, of the subject stereoscopic viewing apparatus. Viewing apparatus 50 includes a viewer section 52, a head mount 70 attached to the viewer section and a head strap 94 attached to the head mount. FIGS. 11A and 11B show the viewing apparatus 50 mounted on a user's head. The viewer section 52 in relevant parts is similar to the prior art hand held viewer 20 of FIGS. 1, 2 and 3. Viewer section 52, which is depicted alone in FIG. 5, includes a viewer housing 54 having a viewing end and a display device securing end on the opposite side. A display device, typically in the form of a SmartPhone, can be installed in the viewer section 52 at the display securing end. A hinged cover 62 can be opened to accept a SmartPhone which is then secured in place by way of cover latch 62A in a manner similar to that of the prior art viewer 20.

The viewing end of viewer housing 54 includes left and right extensions 54L and 54R which, among other things, create a curved upper edge 55 in the housing which roughly corresponds to the lateral curve of a user's forehead. As will be explained, the curved upper edge 55 of the housing and other housing edges do not directly contact the user. A pair of lenses 56L and 56R are located within housing 54 which are installed on an internal lens support panel 58 similar to lenses 44L and 44R and lens panel 42 of the prior art viewer 20. A display actuator 98 as can be seen in FIG. 9B, for example, provides a similar function as actuator 28 of the prior art viewer. Viewer section 52 further includes a recess 58A in lens panel 58, similar to a recess (not designated) in prior art viewer 20, to accommodate the user's nose.

The head mount 70 of the subject viewing apparatus 50, among other important functions, provides a means for securing a head strap 94 to the remainder of the viewing apparatus. In addition, head mount 70 directs most of the forces for supporting the viewing apparatus 50 to the user's forehead rather than other more sensitive areas of the user's face such as the cheeks. This greatly increases user comfort. Head mount 70 is preferably fabricated from a single sheet of material. Note that the phrase “single sheet” is meant here to encompass a laminated sheet. It has been found that a heavy paper is ideal for this application since it is light in weight, low in cost and can be readily cut and formed to create the head mount 70. By way of example, a 14 point C1S Tag stock made by Wausau Coated Products, Inc. of Wausau Wis. can be used.

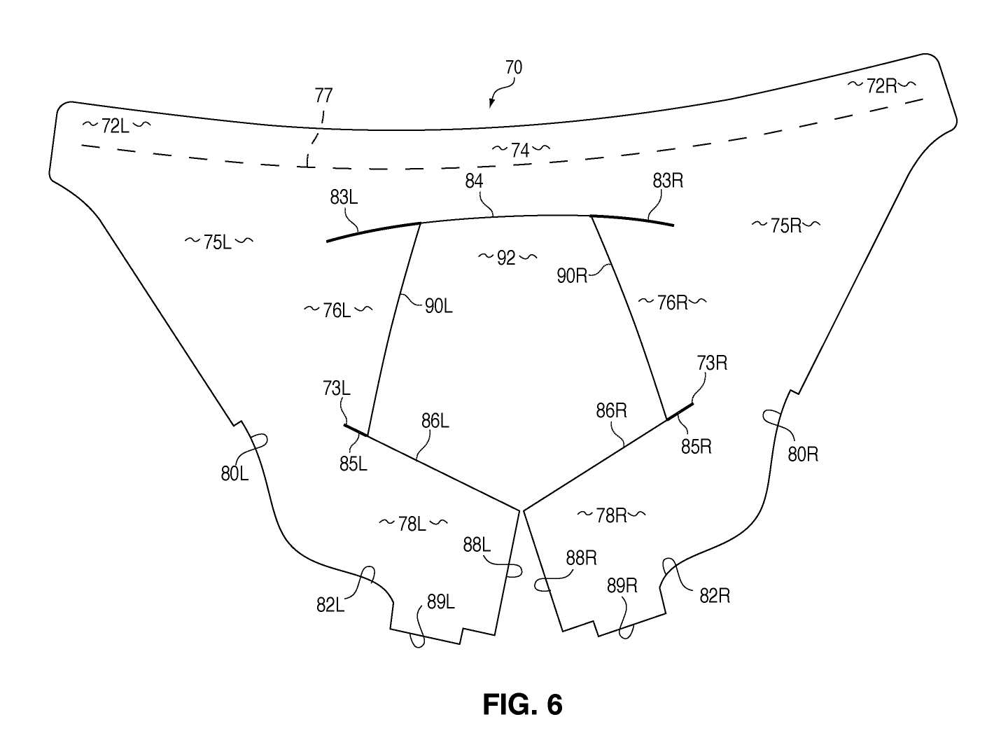

FIG. 6 is a plan view of an exemplary embodiment of the head mount 70 after having been cut from a single sheet of paper but prior to installation on the viewer section 52. The various elements of the planar structure surround a central opening 92. Element 74 will form the elongated forehead segment which will be disposed near and across the top of the viewer housing near edge 55. Left and right side segments 75L and 75R will extend along the respective left and right sides of the housing. Continuing, left and right lower segments 78L and 78R will be disposed over the exterior side of the lower portion of the housing. In addition, left and right stop segments 76L and 76R are formed in the respective left and right side segments 75L and 75R which, among other things, assist in the assembly of the head mount 70. The left stop segment 76L is defined, in part, by cuts 83L and 85L formed in the sheet. Similarly, right stop segment 76R is defined, in part, by cuts 83R and 85R. As will be illustrated later in the drawings, when the head mount 70 is deployed, cut 83L separates into a pair of edges 83AL and 83BL, cut 85L separates into a pair of edges 85AL and 85BL, cut 83R separates into a pair of edges 83AR and 83BR and cut 85R separates into a pair of edges 85AR and 85BR. Not all of these edges are depicted in the drawings.

Adjacent to segments 89L and 89R are a pair of notches (not designated) which form a cutout for accommodating actuator 98 when the head mount 70 is installed. Curved edges 82L and 82R will form a nasal opening when the head mount is installed as can be seen in FIG. 11A for example. (Note that although not shown in FIG. 11A, baffles are present in the interior of the viewer section 52 near the nose recess 58A shown in FIG. 5 to minimize entry of light from the nasal opening of FIG. 9B formed by edges 82L and 82R).

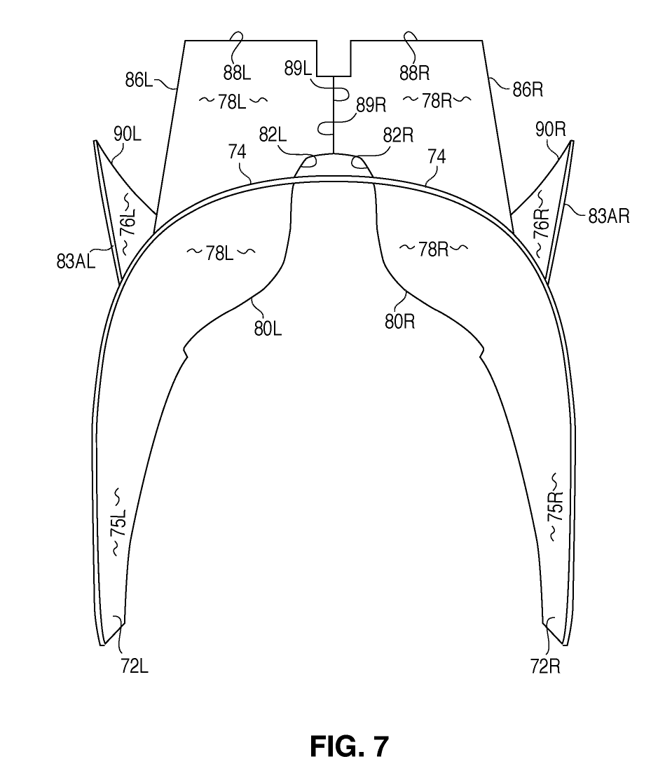

FIG. 7 depicts a plan view of the state the FIG. 6 head mount 70 when the planar structure is twisted on both the left and right side until edges 89L and 89R are abutting one another. This is accomplished by twisting the left lower segment 78L relative to a center portion of the forehead segment 74 in a counter clockwise direction and by twisting the right lower segment 78R relative to center portion of the forehead segment 74 in the clockwise direction. The magnitude of each twist is about 90 degrees. The FIG. 7 configuration remains essentially the same after the twisted head mount 70 is installed on the viewer section 52 as shown in FIG. 9A for example. The double twisted structure 70, will tend to untwist due to memory of the sheet material from which the structure is cut, but maintained when the twisted structure is secured to the viewer section 52 as will be described.

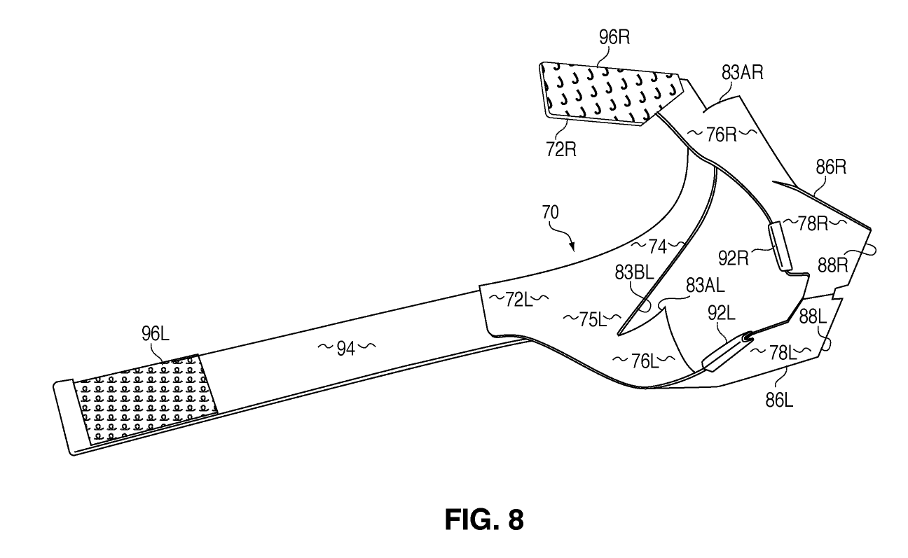

FIG. 8 is another view of the twisted head mount 70 with the head strap 94 attached. This twisting of the planar structure will, among other things, cause a curve to naturally be formed in the forehead segment 74 that generally conforms to a user's forehead and to the curved edge 55 of the viewer housing 54 (FIG. 5). The twisting will further cause the respective ends of the pair of stop segments 76L and 76R to be displaced away from the curved forehead segment 74 so that edge 90L is roughly disposed over edge 86L and edge 90R is roughly disposed over edge 86R.

In order to install the head mount 70 on the viewer section 52, the head mount in planar form is partially manually twisted as previously described so that the pair of stop segments 76L and 76R extend outward as also previously described. The stop segments 76L and 76R are then inserted in the housing 54 (FIG. 5) with the left stop segment 76L being disposed on the interior surface of the left housing extension 54L and with the right stop segment 76R being disposed on the interior surface of the right housing extension 54R. As can be seen in FIGS. 9A-9C, the stop segments 76L and 76R are inserted into the housing 54 until the respective outer edges 90L and 90R abut the lens support panel 58. In addition, the lower edge of the left housing extension 54L is inserted in cut 85L (FIG. 6) of the head mount so that the segment 78L will be disposed on the exterior of housing 54. Similarly, the lower edge of the right housing extension 54R is inserted in cut 85R (FIG. 6) of the head mount so that the segment 78R will be disposed on the exterior of housing 54.

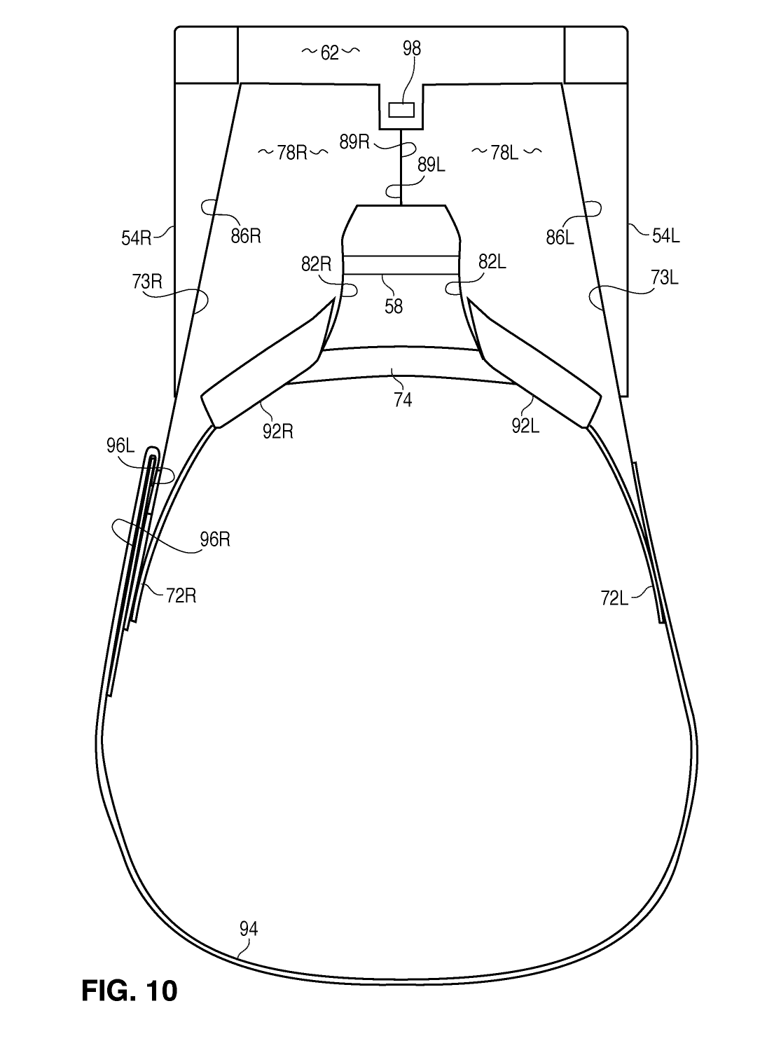

The bottom view FIG. 10 also shows the lower segments 78L and 78R disposed over the exterior of the bottom of housing 54. Note that near the end of cut 85L (FIG. 6) at point 73L (FIGS. 6 and 10) that portion of the lower segment 78L disposed on the interior of housing extension 54L exits the interior and extends over the exterior of the housing. Similarly, near the end of cut 85R (FIG. 6) at point 73R (FIGS. 6 and 10) that portion of the lower segment 78R disposed on the interior of housing extension 54R exits the interior and extends over the exterior of the housing.

FIG. 11A illustrates, by way of further example, housing extension 54L inserted in cut 85L of head mount 70 so that left lower segment 78L of the head mount 70 will be disposed on the exterior surface of the lower portion of housing 54. The end point of cut 85L is designated by 73L In a similar manner, the right the right housing extension 54R inserted in cut 85R so that the right lower segment 78R will be disposed on the exterior surface of the lower portion of housing 54. The exterior of the lower portion of housing 54 presents a relatively flat surface for receiving the lower segments 78L and 78R of the head mount 70 and thus presents an ideal location for attaching the head mount to the housing. Adhesives have been found to be ideal for this application. As can best be seen in FIG. 11A, the respective edges 88L and 88R of lower segments 78L and 78R extend to the outer edge of the lower portion of housing 54 near cover 62. This is a position on the exterior surface of the lower portion of the housing which is well past the location of lenses 56L and 56R.

The head mount 70 at left side segment 75L is also attached to left housing extension 54L using, by way of example, a rivet 57L. Similarly, rivet 57R is used to secure right side segment 75R to the right housing extension 54R. Note that curved forehead segment 74 of head mount 70 extends along curved housing edge 55 but is not attached to the housing in this area. The spacing between housing edge 55 and forehead segment 74 is minimized to reduce light entry in this area. Since the central portion of forehead segment 74 is essentially suspended between the end portions 72L and 72R and since the central portion is separated from housing 52, the forehead segment 74 is free to conform to differing head sizes and differing forehead contours to provide enhanced wearing comfort.

A head strap 94 is attached to the head mount 70 at locations 72L and 72R of the head mount. As can be seen in FIG. 6, attachment locations 72L and 72R fall along the major axis 77 of the elongated forehead segment 74. One end of strap 94 is permanently secured to location 72L (FIG. 8) by way of an adhesive. The free end of strap 94 is detachably connected to location 72R by way of a hook and loop fastener, with the loop half 96L of the fastener being secured to the free end of the strap and the hook half 96R being secured to location 72R. Again, an adhesive can be used to secure the two halves 96L and 96R to the respective free end of strap 94 and to region 72R. The length of loop half 96L is sufficient to allow hook half 96R to be attached at differing locations so as to accommodate differing head sizes. Strap 94 is preferably elastic so as to apply a suitable viewer retaining force.

The combination of viewer section 52 and head mount 70 produce a relatively rigid structure. The viewer section 52 tends exerts a significant downward torque, particularly when a relatively heavy SmartPhone is installed, with this resulting in a force being applied to the user's cheeks. This force can readily reduced to a insignificant value by simply tightening the elastic head band 94. This causes a small torque to be applied to the viewing apparatus that opposes the downward torque so that the force against the user's cheeks is substantially eliminated. In any event, a pair of soft cushions 92L and 92R are installed on edges 80L and 80R (FIG. 6) for contacting the cheeks of the wearer as can best be seen in FIG. 16A to further enhance comfort. The small force applied to the user's cheeks indicates to the user that the viewer is properly positioned. Note that the previously mentioned light baffles that are disposed within housing 54 to reduce entry of light into the housing by way of the nose recess 58A. These baffles are not depicted in FIG. 9B or in the other drawings.

The disclosed exemplary embodiment viewing apparatus is very comfortable and thus can be worn by the user for extended periods of time. Due to the location and geometry of the forehead segment 74 relative to the remainder of the head mount 70 and head strap 94, almost all of weight of the viewer is born by the user's forehead as previously noted. In addition, the head mount 70 operates to greatly reduce entry of light into the viewer section 52. The head mount 70 can be readily produced from a single sheet of material, such as paper and thus is low in both weight and cost. Two simple twists of the head mount 70 in planar form will transform the geometry of the head mount to very near the desired final geometry when it is installed on the viewer section 52. These and other advantages of the disclosed embodiment will be apparent to those skilled in the art upon a reading of the present Detailed Description of the Invention together with the drawings.

1. A stereoscopic viewing apparatus comprising:
a viewer section including
a housing having a display securing end for securing a display device, a viewing end opposite the display securing end, left and right side housing sections and upper and lower housing sections; and
a pair of lenses disposed within the housing intermediate the securing end and the viewing end;
a head mount secured to the viewer housing and including
an elongated forehead segment disposed near the viewing end of the housing near the upper housing section, with the forehead segment including opposing left and right end portions and a curved surface intermediate the left and right end portions and wherein a central portion of the forehead segment intermediate the left and right end portions is unattached to the upper housing section;
with the head mount further comprising a left lower segment extending across at least a portion of the lower housing section and a left side segment extending from the left end portion of the forehead segment to the left lower segment; and
with the head mount further comprising a right lower segment extending across at least a portion of the lower housing section and a right side segment extending from the right end portion of the forehead segment to the right lower segment; and
wherein at least a portion of each of the left and right side segments of the head mount are disposed along respective interior sides of the left and right side housing sections and at least a portion of each of the left and right lower segments of the head mount are disposed along an exterior side of the lower housing section.

2. (canceled)

3. (canceled)

4. The stereoscopic viewing apparatus of claim 1 wherein at least a portion of the left and right lower segments of the head mount extend along the exterior side of the lower housing section from the viewing end of the housing to a position on the exterior side of the lower housing section past a location of the pair of lenses disposed within the housing.

5. The stereoscopic viewing apparatus of claim 4 wherein the pair of lenses are mounted on a lens support panel and wherein the at least a portion of the left side segment of the head mount disposed along the interior side of the left housing section includes a left stop segment which abuts a left side of the lens support panel and wherein the at least a portion of the right side segment of the head mount disposed along an interior side of the right housing section includes a right stop segment which abuts a right side of the lens support panel.

6. The stereoscopic viewing apparatus of claim 1 wherein the head mount is formed from a single sheet of material.

7. The stereoscopic viewing apparatus of claim 6 wherein a portion of each of the left and right side segments of the head mount are disposed at an angle normal to a portion of each of the left and right lower segments of the head mount.

8. The stereoscopic viewing apparatus of claim 7 wherein cutouts are formed in both the left and right lower segments of the head mount so as to accommodate a user's nose.

9. The stereoscopic viewing apparatus of claim 8 further including a head strap attached to the head mount and, together with the elongated forehead segment, are adapted to encircle a user's head.

10. The stereoscopic viewing apparatus of claim 9 wherein the head mount includes first and second head mount attachment points for the head strap that are disposed along a major axis defined by the elongated forehead segment.

11. A stereoscopic viewing apparatus comprising:
a viewer section including
a housing having a display securing end for securing a display device, a viewing end opposite the display securing end, left and right side housing sections and upper and lower housing sections; and
a pair of lenses disposed within the housing intermediate the securing end and the viewing end;
a head mount secured to the viewer housing and including
an elongated forehead segment disposed near the viewing end of the housing near the upper housing section, with the forehead segment including opposing left and right end portions and with a region of the forehead segment intermediate the opposing left and right end portions forming a curved surface which is unattached to the upper housing section;
with the head mount further comprising a left lower segment extending across at least a portion of the lower housing section and a left side segment extending from the left end portion of the forehead segment to the left lower segment;
with the head mount further comprising a right lower segment extending across at least a portion of the lower housing section and a right side segment extending from the right end portion of the forehead segment to the right lower segment; and
wherein the head mount is formed from a single sheet of material.

12. The stereoscopic viewing apparatus of claim 11 wherein the single sheet of material includes paper.

13. (canceled)

14. The stereoscopic viewing apparatus of claim 11 wherein at least a portion of each of the left and right side segments of the head mount are disposed along respective interior sides of the left and right side housing sections.

15. The stereoscopic viewing apparatus of claim 14 wherein at least a portion of each of the left and right lower segments of the head mount are disposed along an exterior side of the lower housing section.

16. The stereoscopic viewing apparatus of claim 15 wherein at least a portion of the left and right lower segments of the head mount extend along the exterior side of the lower housing section from the viewing end of the housing to a position on the exterior side of the lower housing section past a location of the pair of lenses.

17. The stereoscopic viewing apparatus of claim 16 wherein the pair of lenses are mounted on a lens support panel and wherein the left side segment of the head mount disposed along the interior side of the left housing section includes a left stop segment which abuts a left side of the lens support panel and wherein the right side segment of the head mount disposed along the interior side of the right housing section includes a right stop segment which abuts a right side of the lens support panel.

18. A stereoscopic viewing apparatus comprising:
a viewer section including
a housing having a display securing end for securing a display device, a viewing end opposite the display securing end, left and right side housing sections and upper and lower housing sections; and
a pair of lenses disposed within the housing intermediate the securing end and the viewing end;
a head mount including an elongated forehead and including left and right lower segments, with the head mount formed from a single sheet of material by twisting the left lower segment relative to the forehead segment in a first direction and by twisting the right lower segment relative to the elongated forehead segment in a second direction opposite the first direction, with the elongated forehead section being disposed along the viewing end of the upper housing section of the housing, with a central portion of the forehead section being unsecured to the upper housing section and with the left and right lower segments being disposed over and secured to the lower housing section of the housing.

19. The stereoscopic viewing apparatus of claim 18 further including a head strap which together with the elongated forehead segment, are adapted to encircle a user's head, with respective attachment points for the head strap being disposed on the respective right and left end portions of the elongated forehead segment along a major axis of the elongated forehead segment.

20. The stereoscopic viewing apparatus of claim 19 wherein the head mount further includes a left side segment disposed intermediate the left end portion of the forehead segment and the left lower segment and a right side segment disposed intermediate the right end portion of the forehead segment and the right lower segment and wherein at least a portion of each of the left and right side segments of the head mount are disposed along respective interior sides of the left and right side housing sections and the left and right lower segments are each secured to an exterior side of the lower housing section.

21. The stereoscopic viewing apparatus of claim 11 wherein the stereoscopic viewing apparatus further includes a head strap having respective ends attached to respective ones of the left and right end portions of the forehead segment at locations along a major axis defined by the elongated forehead segment.

22. The stereoscopic viewing apparatus of claim 18 wherein the single sheet of material includes paper.
